(19) United States
(12) Patent Application Publication
(10) Pub. No.: US 2022/0142161 A1
(43) Pub. Date: May 12, 2022

(54) METHOD OF IMPROVING THE GROWTH AND/OR THE YIELD OF PLANTS GROWN ON AGRICULTURALLY OR HORTICULTURALLY UTILIZED SUBSTRATES BY APPLYING A NITRICATION INHIBITOR ADDED TO THE IRRIGATION SYSTEM

(71) Applicant: BASF SE, Ludwigshafen (DE)

(72) Inventors: Wolfram Zerulla, St Martin (DE); Gregor Pasda, Limburgerhof (DE); Markus Schmid, Limburgerhof (DE); Daniella Lohe, Ludwigshafen (DE); Manuel Knauer, Limburgerhof (DE)

(21) Appl. No.: 17/436,119

(22) PCT Filed: Mar. 13, 2020
(86) PCT No.: PCT/EP2020/056905

§ 371 Date: Sep. 3, 2021

(30) Foreign Application Priority Data
Mar. 15, 2019 (EP) 19163203.3

(51) Int. Cl. A01N 43/56; C05G 3/90; C05C 3/00

(52) U.S. Cl. CPC A01N 43/56; C05C 3/00; C05G 3/90

(57) ABSTRACT

The present invention relates to a method of improving the growth and/or the yield of plants grown on agriculturally or horticulturally utilized substrates by applying at least one active compound (nitrification inhibitor) on agriculturally or horticulturally utilized substrates, wherein the at least one active compound I is added to the irrigation system in a water-dissolved form.

The present invention relates to a method of improving the growth and/or the yield of plants grown on agriculturally or horticulturally utilized substrates by applying at least one active compound (nitrification inhibitor) on agriculturally or horticulturally utilized substrates, wherein the at least one active compound I is added to the irrigation system in a water-dissolved form.

Nitrogen is an essential element for plant growth, plant health and reproduction. About 5% of the plant available nitrogen in soils (ammonium and nitrate) originate from decomposition processes (mineralization) of organic nitrogen compounds such as humus, plant and animal residues and organic fertilizers. Approximately 5% derive from rainfall. On a global basis, the biggest part (90%), however, are supplied to the plant by organic and inorganic nitrogen fertilizers. The mainly used inorganic nitrogen fertilizers comprise urea and/or ammonium compounds or derivatives thereof, i.e. nearly 90% of the nitrogen fertilizers applied worldwide is in the urea and/or NH₄⁺ form (Subbarao et al., 2012, Advances in Agronomy, 114, 249-302). This is, inter alia, due to the fact that NH₄⁺ assimilation is energetically more efficient than assimilation of other nitrogen sources such as NO₃⁻.

Moreover, being a cation, NH₄⁺ is held electrostatically by the negatively charged clay surfaces and functional groups of soil organic matter. This binding is strong enough to limit NH₄⁺-loss by leaching to groundwater. By contrast, NO₃⁻, being negatively charged, does not bind to the soil and is liable to be leached out of the plants' root zone. In addition, nitrate may be lost by denitrification which is the microbiological conversion of nitrate and nitrite (NO₂⁻) to gaseous forms of nitrogen such as nitrous oxide (N₂O) and molecular nitrogen (N₂).

However, ammonium (NH₄⁺) compounds are converted by soil microorganisms to nitrates (NO₃⁻) in a relatively short time in a process known as nitrification. The nitrification is carried out primarily by two groups of chemolithotrophic bacteria, ammonia-oxidizing bacteria (AOB) of the genus Nitrosomonas and Nitrobacter, which are ubiquitous component of soil bacteria populations. The enzyme, which is essentially responsible for nitrification is ammonia monooxygenase (AMO), which was also found in ammonia-oxidizing archaea (Subbarao et al., 2012, Advances in Agronomy, 114, 249-302).

The nitrification process typically leads to nitrogen losses and environmental pollution. As a result of the various losses, approximately 50% of the applied nitrogen fertilizers is lost during the year following fertilizer addition (see Nelson and Huber; Nitrification inhibitors for corn production (2001), National Corn Handbook, Iowa State University).

As countermeasures, the use of nitrification inhibitors, mostly together with fertilizers, was suggested. Suitable nitrification inhibitors include biological nitrification inhibitors (BNIs) such as linoleic acid, alpha-linolenic acid, methyl p-coumarate, methyl ferulate, MHPP, Karanjin, brachialacton or the p-benzoquinone sorgoleone (Subbarao et al., 2012, Advances in Agronomy, 114, 249-302). Further suitable nitrification inhibitors are synthetic chemical inhibitors such as nitrapyrin, dicyandiamide (DCD), 3,4-dimethyl pyrazole phosphate (DMPP), 4-amino-1,2,4-triazole hydrochloride (ATC), 1-amido-2-thiourea (ASU), 2-amino-4-chloro-6-methylpyrimidine (AM), 5-ethoxy-3-trichloromethyl-1,2,4-thiodiazole (terrazole), or 2-sulfanilamidothiazole (ST) (Slangen and Kerkhoff, 1984, Fertilizer research, 5(1), 1-76).

WO 98/05607 A2 further mentions the use of polyacids to treat mineral fertilizers containing a nitrification inhibitor in order to improve the fixation of the nitrification inhibitors in the inorganic fertilizer. Moreover, the volatility of the nitrification inhibitor can be reduced.

EP 1 378 499 A1 discloses a process for irrigation of agriculturally or horticulturally utilized substrates and the use of nitrification inhibitors in combination with nitrogen-containing fertilizers.

However, the known processes for irrigation using nitrification inhibitors are suboptimal or have certain disadvantages and/or limitations. There were certain limitations regarding the possibilities of application of nitrification inhibitors in combination with irrigation systems.

In view of this situation, there is a continuous need for providing improved irrigation processes or methods using nitrification inhibitors which can lead to higher yields and/or better quality, and providing more possibilities of application of nitrification inhibitors in combination with irrigation systems.

One object of the present invention is to provide a better, and/or more efficient, and/or more cost-efficient method of improving the growth and/or the yield of plants grown on agriculturally or horticulturally utilized substrates using nitrification inhibitors. It is also an object to improve the efficiency of a nitrification inhibitor, in particular to improve the nitrification inhibition.

Another object of the present invention is to provide an irrigation system suitable for the use of nitrification inhibitors.

These objects have been met by the present invention.

The present invention relates to a method of improving the growth and/or the yield of plants grown on agriculturally or horticulturally utilized substrates by applying at least one active compound I (nitrification inhibitor) selected from the group consisting of
a) 2-(3,4-dimethyl-1H-pyrazol-1-yl)succinic acid and/or 2-(4,5-dimethyl-1H-pyrazol-1-yl)succinic acid, and/or a derivative thereof, and/or a salt thereof, e.g. an ammonium salt thereof, and/or a potassium salt thereof, and/or a sodium salt thereof, and/or a magnesium salt thereof, and/or a calcium salt thereof, and/or another salt thereof,
b) glycolic acid addition salt of 3,4-dimethyl pyrazole (3,4-dimethyl pyrazolium glycolate), and/or an isomer thereof, and/or a derivative thereof,
c) citric acid addition salt of 3,4-dimethyl pyrazole (3,4-dimethyl pyrazolium citrate), and/or an isomer thereof, and/or a derivative thereof,
d) lactic acid addition salt of 3,4-dimethyl pyrazole (3,4-dimethyl pyrazolium lactate), and/or an isomer thereof, and/or a derivative thereof,
e) mandelic acid addition salt of 3,4-dimethyl pyrazole (3,4-dimethyl pyrazolium mandelate), and/or an isomer thereof, and/or a derivative thereof,
f) 1,2,4-triazole, and/or a derivative thereof, and/or a salt thereof,
g) 4-Chloro-3-methylpyrazole, and/or an isomer thereof, and/or a derivative thereof, and/or a salt thereof,
h) N-((3(5)-methyl-1H-pyrazole-1-yl)methyl)acetamide, and/or an isomer thereof, and/or a derivative thereof, and/or a salt thereof,
i) N-((3(5)-methyl-1H-pyrazole-1-yl)methyl)formamide, and/or an isomer thereof, and/or a derivative thereof, and/or a salt thereof,
j) N-((3(5),4-dimethylpyrazole-1-yl)methyl)formamide, and/or an isomer thereof, and/or a derivative thereof, and/or a salt thereof,
k) N-((4-chloro-3(5)-methyl-pyrazole-1-yl)methyl)formamide, and/or an isomer thereof, and/or a derivative thereof, and/or a salt thereof,
l) a reaction adduct of dicyandiamide, urea and formaldehyde, or a triazonyl-formaldehyde-dicyandiamide adduct
m) 2-cyano-1-((4-oxo-1,3,5-triazinan-1-yl)methyl)guanidine,
n) 1-((2-cyanoguanidino)methyl)urea, and
o) 2-cyano-1-((2-cyanoguanidino)methyl)guanidine,
p) 2-chloro-6-(trichloromethyl)-pyridine (nitrapyrin or N-serve),
q) dicyandiamide (DCD, DIDIN),
r) 3,4-dimethyl pyrazole phosphate (DMPP, ENTEC), and/or 4,5-dimethyl pyrazole phosphate, and/or 3,5-dimethyl pyrazole phosphate, and/or an isomer thereof, and/or a derivative thereof,
s) 3,4-dimethylpyrazole (DM P), and/or 4,5-dimethylpyrazole, and/or 3,5-dimethyl pyrazole, and/or an isomer thereof, and/or a derivative thereof, and/or a salt thereof, and/or an acid addition salt thereof,
t) ammoniumthiosulfate (ATU),
u) neem, and/or products based on ingredients of neem,
v) linoleic acid,
w) alpha-linolenic acid,
x) methyl p-coumarate,
y) methyl ferulate,
z) methyl 3-(4-hydroxyphenyl) propionate (MHPP),
aa) Karanjin,
bb) brachialacton,
cc) p-benzoquinone sorgoleone,
dd) 4-amino-1,2,4-triazole hydrochloride (ATC),
ee) 1-amido-2-thiourea (ASU),
ff) 2-amino-4-chloro-6-methylpyrimidine (AM),
gg) 2-mercapto-benzothiazole (MBT),
hh) 5-ethoxy-3-trichloromethyl-1,2,4-thiodiazole (terrazole, etridiazole),
ii) 2-sulfanilamidothiazole (ST),
jj) 3-methylpyrazol (3-MP),
kk) 1,2,4-triazol thiourea (TU),
ll) cyan amide,
mm) melamine,
nn) zeolite powder,
oo) catechol,
pp) benzoquinone,
qq) sodium tetra borate,
rr) allylthiourea,
ss) chlorate salts, and
tt) zinc sulfate;

on agriculturally or horticulturally utilized substrates, wherein the at least one active compound I is added to the irrigation system in a water-dissolved form.

The present invention also relates to a method of increasing the inhibition of nitrification on agriculturally or horticulturally utilized substrates fertilized with a fertilizer, in particular a nitrogen containing fertilizer, which comprises applying at least one active compound I as defined herein on agriculturally or horticulturally utilized substrates, wherein the at least one active compound I is applied by an irrigation system in a water-dissolved form. By improving the nitrification inhibition undesirable loss of nitrogen can be reduced and the nitrogen use efficiency the fertilizer can be increased. Thereby plant growth and/or yield of plants can be improved.

Furthermore, the present invention relates to a method of improving the growth and/or the yield of plants grown on agriculturally or horticulturally utilized substrates by applying at least one active compound I (nitrification inhibitor) selected from the group consisting of compounds I.A to I.Z, in particular from the group consisting of I.A, I.B, I.C, I.D and I.E:
I.A: 2-(3,4-dimethyl-1H-pyrazol-1-yl)succinic acid and/or 2-(4,5-dimethyl-1H-pyrazol-1-yl)succinic acid,
I.B: a salt of 2-(3,4-dimethyl-1H-pyrazol-1-yl)succinic acid and/or 2-(4,5-dimethyl-1H-pyrazol-1-yl)succinic acid,
I.C: a potassium salt of 2-(3,4-dimethyl-1H-pyrazol-1-yl)succinic acid and/or 2-(4,5-dimethyl-1H-pyrazol-1-yl)succinic acid, i.e. a mono or dipotassium salt thereof,
I.D: an ammonium salt of 2-(3,4-dimethyl-1H-pyrazol-1-yl)succinic acid and/or 2-(4,5-dimethyl-1H-pyrazol-1-yl)succinic acid, i.e. a mono or diammonium salt thereof,
I.E: a sodium salt of 2-(3,4-dimethyl-1H-pyrazol-1-yl)succinic acid and/or 2-(4,5-dimethyl-1H-pyrazol-1-yl)succinic acid, i.e. a mono or disodium salt thereof,
I.F: 3,4-dimethyl pyrazolium glycolate (DMPG),
I.G: 3,4-dimethyl pyrazolium citrate (DMPC),
I.H: 3,4-dimethyl pyrazolium lactate (DMPL),
I.J: 3,4-dimethyl pyrazolium lactate (DMPM),
I.K: 1,2,4-triazole (TZ),
I.L: 4-Chloro-3-methylpyrazole (CIMP),
I.M: N-((3(5)-methyl-1H-pyrazole-1-yl)methyl)acetamide,
I.N: N-((3(5)-methyl-1H-pyrazole-1-yl)methyl)formamide,
I.O: N-((3(5),4-dimethylpyrazole-1-yl)methyl)formamide,
I.P: N-((4-chloro-3(5)-methyl-pyrazole-1-yl)methyl)formamide,
I.Q: reaction adduct of dicyandiamide, urea and formaldehyde, or a triazonyl-formaldehyde-dicyandiamide adduct,
I.R: 2-cyano-1-((4-oxo-1,3,5-triazinan-1-yl)methyl)guanidine,
I.S: 1-((2-cyanoguanidino)methyl)urea,
I.T: 2-cyano-1-((2-cyanoguanidino)methyl)guanidine,
I.U: 2-chloro-6-(trichloromethyl)-pyridine (nitrapyrin or N-serve),
I.V: dicyandiamide (DCD, DIDIN),
I.W: 3,4-dimethyl pyrazole phosphate (DMPP, ENTEC), and/or 4,5-dimethyl pyrazole phosphate,
I.X: 3,4-dimethylpyrazole (DM P), and/or 4,5-dimethylpyrazole,
I.Y: ammoniumthiosulfate (ATU), and
I.Z: neem,

on agriculturally or horticulturally utilized substrates, wherein the at least one active compound I is added to the irrigation system in a water-dissolved form.

The present invention also relates to a method of increasing the inhibition of nitrification on agriculturally or horticulturally utilized substrates fertilized with a fertilizer, in particular a nitrogen containing fertilizer, which comprises applying at least one active compound I, which is selected from the group consisting of compounds I.A to I.Z, in particular from the group consisting of I.A, I.B, I.C, I.D and I.E, on agriculturally or horticulturally utilized substrates, wherein the at least one active compound I is applied by an irrigation system in a water-dissolved form.

The term “added to the irrigation system in a water-dissolved form” generally means that the compound is dissolved in the water used for irrigation. This includes the direct dissolution of the active compound I in the water used for irrigation as well as providing the compound I as an aqueous formulation and adding dosing this aqueous formulation to the water used for irrigation with preference given to the latter.

By the methods of the invention, the compound I, i.e. the nitrification inhibitor, is applied to the agriculturally or horticulturally utilized substrates together with the water used for irrigation. Thereby an efficient and even distribution of the compound I is achieved.

In one preferred embodiment of the invention, compound I is 2-(3,4-dimethyl-1H-pyrazol-1-yl)succinic acid and/or 2-(4,5-dimethyl-1H-pyrazol-1-yl)succinic acid, and/or a derivative thereof, and/or an ammonium salt thereof, and/or a potassium salt thereof, and/or a sodium salt thereof, and/or a magnesium salt thereof, and/or a and/or another salt thereof. Sodium salts may be mono or disodium salts. Potassium salts may be mono or dipotassium salts. Ammonium salts may be mono- or diammonium salts.

Here and in the following, the term DMPSA refers to 2-(3,4-dimethyl-1H-pyrazol-1-yl)succinic acid, to 2-(4,5-dimethyl-1H-pyrazol-1-yl)succinic acid and to mixtures thereof and also to salts and derivatives thereof as well as to mixtures of the salts and/or derivatives of 2-(3,4-dimethyl-1H-pyrazol-1-yl)succinic acid and 2-(4,5-dimethyl-1H-pyrazol-1-yl)succinic acid.

Suitable salts of 2-(3,4-dimethyl-1H-pyrazol-1-yl)succinic acid and 2-(4,5-dimethyl-1H-pyrazol-1-yl)succinic are e.g. the mono- and diammonium salts thereof, the mono- and disodium salts thereof, the mono- and dipotassium salts thereof and the magnesium salts thereof.

Suitable derivatives of 2-(3,4-dimethyl-1H-pyrazol-1-yl)succinic acid and 2-(4,5-dimethyl-1H-pyrazol-1-yl)succinic acid are e.g. the mono- and diesters, in particular the mono-C₁-C₄-alkyl esters, the di-C₁-C₄-alkyl esters, the mono-C₂-C₄-hydroxyalkyl esters, the di-C₂-C₄-hydroxyalkyl esters thereof.

In particular, the compound I is 2-(3,4-dimethyl-1H-pyrazol-1-yl)succinic acid and/or 2-(4,5-dimethyl-1H-pyrazol-1-yl)succinic acid, and/or a salt thereof, such as an mono- and diammonium salt thereof, a mono- or dipotassium salt thereof, a mono-disodium salt thereof, or a magnesium salt thereof.

More particularly, the compound I is 2-(3,4-dimethyl-1H-pyrazol-1-yl)succinic acid or a salt thereof or a mixture of 2-(3,4-dimethyl-1H-pyrazol-1-yl)succinic acid and 2-(4,5-dimethyl-1H-pyrazol-1-yl)succinic acid or a mixture of the salts thereof, where the mixture predominately contains 2-(3,4-dimethyl-1H-pyrazol-1-yl)succinic acid or a salt thereof, in particular a mono- or diammonium salt thereof, a mono- or dipotassium salt thereof or a mono-disodium salt thereof.

In said mixtures the weight ratio of 2-(3,4-dimethyl-1H-pyrazol-1-yl)succinic acid to 2-(4,5-dimethyl-1H-pyrazol-1-yl)succinic acid is preferably at least 1.5:1, in particular at least 2:1, e.g. in the range from 1.5:1 to 99:1, in particular in the range from 2:1 to 9:1, especially in the range from 3:1 to 7:1.

In a particularly preferred embodiment of the invention, the compound I is a compound I.A, i.e. 2-(3,4-dimethyl-1H-pyrazol-1-yl)succinic acid and/or 2-(4,5-dimethyl-1H-pyrazol-1-yl)succinic acid, especially a mixture of 2-(3,4-dimethyl-1H-pyrazol-1-yl)succinic acid and 2-(4,5-dimethyl-1H-pyrazol-1-yl)succinic acid, where the mixture predominately contains 2-(3,4-dimethyl-1H-pyrazol-1-yl)succinic acid. In said mixtures the weight ratio of 2-(3,4-dimethyl-1H-pyrazol-1-yl)succinic acid to 2-(4,5-dimethyl-1H-pyrazol-1-yl)succinic acid is preferably at least 1.5:1, in particular at least 2:1, e.g. in the range from 1.5:1 to 99:1, in particular in the range from 2:1 to 9:1, especially in the range from 3:1 to 7:1.

In another particularly preferred embodiment of the invention, the compound I is a compound I.B, i.e. a salt of 2-(3,4-dimethyl-1H-pyrazol-1-yl)succinic acid and/or a salt of 2-(4,5-dimethyl-1H-pyrazol-1-yl)succinic acid. In this particular embodiment, the compound I.B is especially a mixture of the salt of 2-(3,4-dimethyl-1H-pyrazol-1-yl)succinic acid and the salt of 2-(4,5-dimethyl-1H-pyrazol-1-yl)succinic acid, where the mixture predominately contains the salt of 2-(3,4-dimethyl-1H-pyrazol-1-yl)succinic acid. In said mixtures the weight ratio of 2-(3,4-dimethyl-1H-pyrazol-1-yl)succinic acid to 2-(4,5-dimethyl-1H-pyrazol-1-yl)succinic acid is preferably at least 1.5:1, in particular at least 2:1, e.g. in the range from 1.5:1 to 99:1, in particular in the range from 2:1 to 9:1, especially in the range from 3:1 to 7:1.

In another particularly preferred embodiment of the invention, the compound I is a compound I.D, i.e. an ammonium salt of 2-(3,4-dimethyl-1H-pyrazol-1-yl)succinic acid and/or 2-(4,5-dimethyl-1H-pyrazol-1-yl)succinic acid, i.e. a mono- or diammoniumsalt thereof. In this particular embodiment, the compound I.D is especially a mixture of the mono- or diammonium salt of 2-(3,4-dimethyl-1H-pyrazol-1-yl)succinic acid and the mono- or diammonium salt of 2-(4,5-dimethyl-1H-pyrazol-1-yl)succinic acid, where the mixture predominately contains the mono- or diammonium salt of 2-(3,4-dimethyl-1H-pyrazol-1-yl)succinic acid. In said mixtures the weight ratio of 2-(3,4-dimethyl-1H-pyrazol-1-yl)succinic acid to 2-(4,5-dimethyl-1H-pyrazol-1-yl)succinic acid is preferably at least 1.5:1, in particular at least 2:1, e.g. in the range from 1.5:1 to 99:1, in particular in the range from 2:1 to 9:1, especially in the range from 3:1 to 7:1.

In another particularly preferred embodiment of the invention, the compound I is a compound I.C, i.e. a potassium salt of 2-(3,4-dimethyl-1H-pyrazol-1-yl)succinic acid and/or 2-(4,5-dimethyl-1H-pyrazol-1-yl)succinic acid, i.e. a mono- or dipotassiumsalt thereof. In this particular embodiment, the compound I.C is especially a mixture of the mono- or dipotassiumsalt salt of 2-(3,4-dimethyl-1H-pyrazol-1-yl)succinic acid and the mono- or dipotassiumsalt salt of 2-(4,5-dimethyl-1H-pyrazol-1-yl)succinic acid, where the mixture predominately contains the mono- or dipotassiumsalt salt of 2-(3,4-dimethyl-1H-pyrazol-1-yl)succinic acid. In said mixtures the weight ratio of 2-(3,4-dimethyl-1H-pyrazol-1-yl)succinic acid to 2-(4,5-dimethyl-1H-pyrazol-1-yl)succinic acid is preferably at least 1.5:1, in particular at least 2:1, e.g. in the range from 1.5:1 to 99:1, in particular in the range from 2:1 to 9:1, especially in the range from 3:1 to 7:1.

In another particularly preferred embodiment of the invention, the compound I is a compound I.E, i.e. a sodium salt of 2-(3,4-dimethyl-1H-pyrazol-1-yl)succinic acid and/or 2-(4,5-dimethyl-1H-pyrazol-1-yl)succinic acid, i.e. a mono- or disodiumsalt thereof. In this particular embodiment, the compound I.E is especially a mixture of the mono- or disodiumsalt of 2-(3,4-dimethyl-1H-pyrazol-1-yl)succinic acid and the mono- or disodiumsalt of 2-(4,5-dimethyl-1H-pyrazol-1-yl)succinic acid, where the mixture predominately contains the mono- or disodiumsalt of 2-(3,4-dimethyl-1H-pyrazol-1-yl)succinic acid. In said mixtures the weight ratio of 2-(3,4-dimethyl-1H-pyrazol-1-yl)succinic acid to 2-(4,5-dimethyl-1H-pyrazol-1-yl)succinic acid is preferably at least 1.5:1, in particular at least 2:1, e.g. in the range from 1.5:1 to 99:1, in particular in the range from 2:1 to 9:1, especially in the range from 3:1 to 7:1.

Generally, the compound I (nitrification inhibitor) used in the method of the invention can be contained in varying amounts in the irrigation water. Preferably, the amount of the compound I (nitrification inhibitor), in particular the amount of the compounds I.A, I.B, I.C, I.D and I.E, in the irrigation water is chosen such the application rate of these compounds is in the range of 100 to 3000 g/kg. In particular, the amount of these compounds in the irrigation water is in the range from 2×10⁻⁴ g/L to 30 g/L, in particular 3×10⁻⁴ g/L to 20 g/L, especially 5×10⁻⁴ g/L to 10 g/L or 10⁻³ g/L to 5 g/L.

The compound I, in particular the compounds I.A, I.B, I.C, I.D and/or I.E as such or as a water-dilutable formulation to the irrigation system and thus to the water of the irrigation system. In particular, they are added to the irrigation system and thus to the water of the irrigation system by dosing an aqueous formulation of the compound I, in particular an aqueous solution of at least one of the compounds I.A, I.B, I.C, I.D and/or I.E to the water of the irrigation system. The amount of the compound I, in particular the amount of the compounds I.A, I.B, I.C, I.D and I.E, in such a formulation is usually not more than 75 wt. %, more preferably not more than 70% by weight, for example in a range from 0.1 to 75 wt. %, in particular in the range from 1 to 75% by weight or from 10 to 75% by weight, based on the total weight of the aqueous formulation.

An “irrigation system” is any system through which water is automatically or semi-automatically or by hand provided and distributed to agriculturally or horticulturally utilized substrates. The irrigation system is preferably a drip irrigation system, a trickle irrigation system, a sprinkler irrigation system, a surface irrigation system, a furrow irrigation system, a center pivot irrigation system, an irrigation system based on crop protection sprayers, a vehicle-based irrigation system, and/or a subsurface irrigation system. Preference is given to irrigation systems where water is provided to the agriculturally or horticulturally utilized substrates in the form of droplets such as drip irrigation systems, trickle irrigation system, sprinkler irrigation systems, a center pivot irrigation system, an irrigation system based on crop protection sprayers. Also suitable are surface irrigation system and furrow irrigation system. In particular the invention is particularly suitable for irrigation systems were no or only small amounts of surplus water are required to achieve satisfactory irrigation, including drip irrigation systems and trickle irrigation systems.

“Agriculturally or horticulturally utilized substrates” are any substrates in which plants can grow and/or build up roots.

Plants are preferably plants of the following crops:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

Especially preferred crops are crops of cereals, corn, soybeans, rice, oilseed rape, cotton, potatoes, peanuts, sugar beets, sugar cane or permanent crops as well as all kinds of vegetables.

The mixtures or compositions according to the invention can also be used in crops which have been modified by mutagenesis or genetic engineering in order to provide a new trait to a plant or to modify an already present trait.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

In the method of the invention the compound I is applied on agriculturally or horticulturally utilized substrates, in a water-dissolved form by means of an irrigation system. Frequently, this application is combined with an application of at least one fertilizer, in particular at least one nitrogen fertilizer, which comprises or is in particular an inorganic nitrogen fertilizer. The fertilizer may be applied jointly with or separately from the compound I. In the context of the invention, jointly means that the fertilizer and the compound I are applied to the agriculturally or horticulturally utilized substrate by means of the irrigation system at the same time. In the context of the invention, separately means that the fertilizer is applied to the agriculturally or horticulturally utilized substrate not by means of the irrigation system or at another time. For example, the fertilizer is applied directly on the agriculturally or horticulturally utilized substrate without using an irrigation system and/or the fertilizer is applied by using an irrigation system at another time. For example, there may be a time interval between the application of the fertilizer and the compound I, which is an interval of at least 1 hour, or 2 hours, or 3 hours, or 4 hours, or 5 hours, or 6 hours, or 7 hours, or 8 hours, or 9 hours, or 10 hours, or 11 hours, or 12 hours, or 13 hours, or 14 hours, or 15 hours, or 16 hours, or 17 hours, or 18 hours, or 19 hours, or 20 hours, or 21 hours, or 22 hours, or 23 hours, or 24 hours or at least 1 day, or 2 days, or 3 days, or 4 days, or 5 days, or 6 days, or 7 days, or 8 days, or 9 days, or 10 days, or 11 days, or 12 days, or 13 days, or 14 days, or 15 days, or 16 days, or 17 days, or 18 days, or 19 days, or 20 days, or 21 days, or 22 days, or 23 days, or 24 days, or 25 days, or 26 days, or 27 days, or 28 days, or 29 days, or 30 days.

The term “fertilizers” is to be understood as chemical compounds applied to promote plant and fruit growth. Fertilizers are typically applied either through the soil (for uptake by plant roots), through soil substituents (also for uptake by plant roots), or by foliar feeding (for uptake through leaves). The term also includes mixtures of one or more different types of fertilizers as mentioned below.

The term “fertilizers” can be subdivided into several categories including: a) organic fertilizers (composed of plant/animal matter), b) inorganic fertilizers (composed of chemicals and minerals) and c) urea-containing fertilizers.

Organic fertilizers include manure, e.g. liquid manure, semi-liquid manure, biogas manure, stable manure or straw manure, slurry, liquid dungwater, sewage sludge, worm castings, peat, seaweed, compost, sewage, and guano. Green manure crops (cover crops) are also regularly grown to add nutrients (especially nitrogen) to the soil. Manufactured organic fertilizers include e.g. compost, blood meal, bone meal and seaweed extracts. Further examples are enzyme digested proteins, fish meal, and feather meal. The decomposing crop residue from prior years is another source of fertility.

Inorganic fertilizers are usually manufactured through chemical processes (such as e.g. the Haber-Bosch process), also using naturally occurring deposits, while chemically altering them (e.g. concentrated triple superphosphate). Naturally occurring inorganic fertilizers include Chilean sodium nitrate, mine rock phosphate, limestone, sulfate of potash, muriate of potash, and raw potash fertilizers.

Typical solid fertilizers are in a crystalline, prilled or granulated form. Typical nitrogen containing inorganic fertilizers are ammonium nitrate, calcium ammonium nitrate, ammonium sulfate, ammonium sulfate nitrate, calcium nitrate, diammonium phosphate, monoammonium phosphate, ammonium thio sulfate and calcium cyanamide.

The nitrogen containing inorganic fertilizer may be an NP fertilizer, an NK fertilizer or an NPK fertilizer. “NPK fertilizers” are inorganic fertilizers formulated in appropriate concentrations and combinations comprising the three main nutrients nitrogen (N), phosphorus (P) and potassium (K) as well as typically S, Mg, Ca, and trace elements. “N K fertilizers” comprise the two main nutrients nitrogen (N) and potassium (K) as well as typically S, Mg, Ca, and trace elements. “NP fertilizers” comprise the two main nutrients nitrogen (N) and phosphorus (P) as well as typically S, Mg, Ca, and trace elements. NP, NK and NPK can be complex fertilizers (all nutrients are in each fertilizer granule or prill) or physical mixtures of N-containing, P-containing and/or K-containing fertilizers (each fertilizer granule differs in kind of nutrient and amount).

Urea-containing fertilizer may, in specific embodiments, be formaldehyde urea, UAN, urea sulfur, stabilized urea, urea based NK-, NP- and NPK-fertilizers, or urea ammonium sulfate. Also envisaged is the use of urea as fertilizer.

Fertilizers may be provided in any suitable form, e.g. as coated or uncoated granules, in liquid or semi-liquid form, as sprayable fertilizer, or via fertigation etc.

Coated fertilizers may be provided with a wide range of materials. Coatings may, for example, be applied to granular or prilled nitrogen (N) fertilizer or to multi-nutrient fertilizers. Typically, urea is used as base material for most coated fertilizers. The present invention, however, also envisages the use of other base materials for coated fertilizers, any one of the fertilizer materials defined herein. In certain embodiments, elemental sulfur may be used as fertilizer coating. The coating may be performed by spraying molten S over urea granules, followed by an application of sealant wax to close fissures in the coating. In a further embodiment, the S layer may be covered with a layer of organic polymers, preferably a thin layer of organic polymers. In another embodiment, the coated fertilizers are preferably physical mixtures of coated and non-coated fertilizers.

Further envisaged coated fertilizers may be provided by reacting resin-based polymers on the surface of the fertilizer granule. A further example of providing coated fertilizers includes the use of low permeability polyethylene polymers in combination with high permeability coatings.

In specific embodiments, the composition and/or thickness of the fertilizer coating may be adjusted to control, for example, the nutrient release rate for specific applications. The duration of nutrient release from specific fertilizers may vary, e.g. from several weeks to many months.

Coated fertilizers may be provided as controlled release fertilizers (CRFs). In specific embodiments these controlled release fertilizers are fully coated N-P-K fertilizers, which are homogeneous and which typically show a pre-defined longevity of release. In further embodiments, the CRFs may be provided as blended controlled release fertilizer products which may contain coated, uncoated and/or slow release components. In certain embodiments, these coated fertilizers may additionally comprise micronutrients. In specific embodiments these fertilizers may show a pre-defined longevity, e.g. in case of N-P-K fertilizers.

Additionally envisaged examples of CRFs include patterned release fertilizers. These fertilizers typically show a pre-defined release patterns (e.g. hi/standard/lo) and a pre-defined longevity. In exemplary embodiments fully coated N-P-K, Mg and micronutrients may be delivered in a patterned release manner.

Also envisaged are double coating approaches or coated fertilizers based on a programmed release.

In further embodiments, the fertilizer mixture may be provided as, or may comprise or contain a slow release fertilizer. The fertilizer may, for example, be released over any suitable period of time, e.g. over a period of 1 to 5 months, preferably up to 3 months. Typical examples of ingredients of slow release fertilizers are IBDU (isobutylidenediurea), e.g. containing about 31-32% nitrogen, of which 90% is water insoluble; or UF, i.e. an urea-formaldehyde product which contains about 38% nitrogen of which about 70% may be provided as water insoluble nitrogen; or CDU (crotonylidene diurea) containing about 32% nitrogen; or MU (methylene urea) containing about 38 to 40% nitrogen, of which 25-60% is typically cold water insoluble nitrogen; or MDU (methylene diurea) containing about 40% nitrogen, of which less than 25% is cold water insoluble nitrogen; or MO (methylol urea) containing about 30% nitrogen, which may typically be used in solutions; or DMTU (diimethylene triurea) containing about 40% nitrogen, of which less than 25% is cold water insoluble nitrogen; or TMTU (tri methylene tetraurea), which may be provided as component of UF products; or TMPU (tri methylene pentaurea), which may also be provided as component of UF products; or UT (urea triazone solution) which typically contains about 28% nitrogen. The fertilizer mixture may also be long-term nitrogen-bearing fertiliser containing a mixture of acetylene diurea and at least one other organic nitrogen-bearing fertiliser selected from methylene urea, isobutylidene diurea, crotonylidene diurea, substituted triazones, triuret or mixtures thereof.

Any of the above mentioned fertilizers or fertilizer forms may suitably be combined. For instance, slow release fertilizers may be provided as coated fertilizers. They may also be combined with other fertilizers or fertilizer types. The same applies to the presence of the composition of the present invention, which may be adapted to the form and chemical nature of the fertilizer and accordingly be provided such that its release accompanies the release of the fertilizer, e.g. is released at the same time or with the same frequency.

In a preferred embodiment of the invention, the fertilizer (F) is selected from the group consisting of ammonium nitrate, calcium ammonium nitrate, ammonium sulfate, ammonium sulfate nitrate, calcium nitrate, diammonium phosphate, monoammonium phosphate, ammonium thio sulfate, calcium cyanamide, NP, NK and NPK complex fertilizers, physical mixtures of salts and/or fertilizers each containing N, P and/or K, anhydrous ammonia, urea, urea ammonium nitrate (UAN), urea ammonium sulfate, magnesium salts, calcium salts, sulfur containing compounds, trace elements selected from the group consisting of manganese (Mn), zinc (Zn), copper (Cu), iron (Fe), boron (B), chlorine (Cl), nickel (Ni), molybdenum (Mo).

In a preferred embodiment of the invention, a fertilizer (F) is additionally, i.e. separately from the compound I, applied on agriculturally or horticulturally utilized substrates.

In another embodiment of the invention, a mixture comprising the at least one active compound I and a fertilizer (F) is added to the irrigation system. The fertilizer, including any nutrient salts, and the compound I may be added separately to the irrigation system. The fertilizer, including any nutrient salts, and the compound I may be added jointly to the irrigation system.

In another embodiment of the invention, the at least one active compound I is added to the irrigation system and a fertilizer (F) is added to the same irrigation system with a time interval of at least 1 hour, or 2 hours, or 3 hours, or 4 hours, or 5 hours, or 6 hours, or 7 hours, or 8 hours, or 9 hours, or 10 hours, or 11 hours, or 12 hours, or 13 hours, or 14 hours, or 15 hours, or 16 hours, or 17 hours, or 18 hours, or 19 hours, or 20 hours, or 21 hours, or 22 hours, or 23 hours, or 24 hours.

In another embodiment of the invention, the at least one active compound I is added to the irrigation system and a fertilizer (F) is added to the same irrigation system with a time interval of at least 1 day, or 2 days, or 3 days, or 4 days, or 5 days, or 6 days, or 7 days, or 8 days, or 9 days, or 10 days, or 11 days, or 12 days, or 13 days, or 14 days, or 15 days, or 16 days, or 17 days, or 18 days, or 19 days, or 20 days, or 21 days, or 22 days, or 23 days, or 24 days, or 25 days, or 26 days, or 27 days, or 28 days, or 29 days, or 30 days.

In another particularly preferred embodiment of the invention, a fertilizer (F) is applied on agriculturally or horticulturally utilized substrates without being added to the irrigation system, particularly a fertilizer (F) is applied on agriculturally or horticulturally utilized substrates by hand and/or by a spreader device. The spreader device can be preferably moved by machines, vehicles, animals, and/or humans.

In particular, the at least one active compound I, in particular the compound I.A, I.B, I.C, I.D or I.E, is added to the irrigation system and a fertilizer (F) is applied on agriculturally or horticulturally utilized substrates without being added to the irrigation system with a time interval of at least 1 hour, or 2 hours, or 3 hours, or 4 hours, or 5 hours, or 6 hours, or 7 hours, or 8 hours, or 9 hours, or 10 hours, or 11 hours, or 12 hours, or 13 hours, or 14 hours, or 15 hours, or 16 hours, or 17 hours, or 18 hours, or 19 hours, or 20 hours, or 21 hours, or 22 hours, or 23 hours, or 24 hours.

In particular, the at least one active compound I, in particular the compound I.A, I.B, I.C, I.D or I.E, is added to the irrigation system and a fertilizer (F) is applied on agriculturally or horticulturally utilized substrates without being added to the irrigation system with a time interval of at least 1 day, or 2 days, or 3 days, or 4 days, or 5 days, or 6 days, or 7 days, or 8 days, or 9 days, or 10 days, or 11 days, or 12 days, or 13 days, or 14 days, or 15 days, or 16 days, or 17 days, or 18 days, or 19 days, or 20 days, or 21 days, or 22 days, or 23 days, or 24 days, or 25 days, or 26 days, or 27 days, or 28 days, or 29 days, or 30 days.

Preferably and as far as a fertilizer (F) is either added to the irrigation system or applied on agriculturally or horticulturally utilized substrates, the weight ratio of the active compound I, which is preferably a compound I.A, I.B, I.C, I.D or I.E, and the fertilizer (F) is at least 1:30000, most preferably at least 1:10000, particularly at least 1:5000, particularly at least 1:1000, particularly most preferably at least 1:200, particularly at least 1:100, for example at least 1:80.

More preferably, and as far as a fertilizer (F) is either added to the irrigation system or applied on agriculturally or horticulturally utilized substrates, the weight ratio of the active compound I, which is preferably a compound I.A, I.B, I.C, I.D or I.E, and the fertilizer (F) is from 1:30000 to 1:2, most preferably from 1:10000 to 1:3, particularly preferably from 1:5000 to 1:6, particularly more preferably of from 1:1000 to 1:10, particularly most preferably from 1:200 to 1:20, particularly from 1:100 to 1:30, for example from 1:80 to 1:50.

In another preferred embodiment of the invention, no fertilizer (F) is applied on agriculturally or horticulturally utilized substrates.

Usually, the weight ratio of the active compound I, which is preferably a compound I.A, I.B, I.C, I.D or I.E, and the irrigation water added to the irrigation system is at least 1:5000000, in particular at least 1:3000000, preferably at least 1:1000000, more preferably at least 1:500000, particularly at least 1:300000.

Frequently, the weight ratio of the active compound I, which is preferably a compound I.A, I.B, I.C, I.D or I.E, and the irrigation water added to the irrigation system is from 1:5000000 to 1:50, preferably 1:3000000 to 1:200, in particular from 1:1000000 to 1:300, more preferably from 1:500000 to 1:600, especially from 1:300000 to 1:1000.

In a preferred embodiment of the invention, the active compound I, which is preferably a compound I.A, I.B, I.C, I.D or I.E, is applied via a drip irrigation system, a trickle irrigation system, a sprinkler irrigation system, a surface irrigation system, a furrow irrigation system, a center pivot irrigation system, an irrigation system based on crop protection sprayers, a vehicle-based irrigation system, and/or a subsurface irrigation system. In a particularly preferred embodiment of the invention, the active compound I, which is preferably a compound I.A, I.B, I.C, I.D or I.E, is applied via a drip irrigation system, a trickle irrigation system, and/or a subsurface irrigation system.

The following examples server for the illustration of the present invention:

### Abbreviations

n.d. not determined
NI nitrification inhibitor
DAT days after treatment

In the examples the following materials were used:

DMPSA: Mixture of 2-(3,4-dimethyl-1H-pyrazol-1-yl)succinic acid and 2-(4,5-dimethyl-1H-pyrazol-1-yl)succinic acid in a weight ratio of at least 3:1 in the form of the free acid.

DMPP: 3,4-dimethyl pyrazole phosphate.

Nitrapyrin: Commercial composition of 2-chloro-6-(trichloromethyl)pyridine (N-Serve® of Corteva)

DCD: Commercial dicyandiamide product

Triazole+3MP: Commercial composition of 1,2,4-triazol and 3-methylpyrazole (Piadin® of SKW Piesteritz)

In the examples a standardized sandy loam soil with coarse and very light texture was used. The soil contained 73% by weight of sand, 24% of silt and 3% of loam and had a pH of 6.8, a maximum water holding capacity of 25% by weight and a Cₜ value of 0.7 corresponding to 1.2% by weight of humus.

### EXAMPLE 1

For each test, three 500 ml plastic bottles were filled with 100 g of air dried soil each. Soil was moistened with deionized water to 50% of its water holding capacity. Then, the soil was incubated for two weeks at 20° C. to activate the microbial biomass. Ammonium sulfate was dissolved in deionized water in an amount corresponding to a nitrogen concentration of 10 g/L and supplemented by the desired amount of nitrogen inhibitor in an amount given in table 1. To each bottle 1 ml of the test solution was added by dripping the test solution with a pipette to the soil to simulate drop irrigation. Bottles were loosely capped to avoid contamination by dirt but to allow air exchange. The bottles were incubated at 20° C. for 0 to 42 days.

For determining the nitrogen content in the soil after incubation, to each bottle 300 mL of a 1% by weight solution of potassium sulfate in deionized water was added and the bottle was shaken for 2 h in a horizontal shaker at 150 rpm. Then the whole content of the bottle was filtered through a paper filter (MN 807 of Macherey-Nagel) and the filtrate was analyzed photometrically at 550 nm with respect to ammonium and nitrate by means of an auto analyzer AA11 of Merck.

Inhibition of nitrification was calculated by the following equation 1 (Bohland equation, DD 123771):

$$\% inhibition = \frac{N ( {NO}_{3} ) 1 - N ( {NO}_{3} ) 2}{N ( {NO}_{3} ) 1 - N ( {NO}_{3} ) 3} \times 100 \qquad ( 1 )$$

N (NO₃) 1=Concentration of nitrogen contributed by NO₃ without NI at the end of incubation

N (NO₃) 2=Concentration of nitrogen contributed by NO₃ with NI at the end of incubation

N (NO₃) 2=Concentration of nitrogen contributed by NO₃ at the beginning of incubation

The Examples were carried out in two separate series 1 and 2. The results of the first and second series are summarized in the following tables 1 and 2. All results are averages of 3 replications.

TABLE 4
NH₄ recovery and nitrification inhibition (first series)

| | | % NH₄ recovery of applied NH₄ | | | % nitrification inhibition | | |
|---|---|---|---|---|---|---|---|
| NI | NI/N (NH₄)¹ | DAT14 | DAT28 | DAT42 | DAT14 | DAT28 | DAT42 |
| — | 0 | 2 | 0 | 0 | 0 | 0 | 0 |
| DMPSA | 0.8% | 82 | 48 | 27 | 74 | 59 | 34 |
| DCD | 10% | 63 | 13 | 0 | 59 | 15 | 3 |
| Nitrapyrin | 0.8% | 31 | 3 | 0 | 33 | 4 | −2 |

1) NI/N (NH₄): weight ratio of nitrogen inhibitor to nitrogen contributed by ammonium sulfate
2) calculated according to equation 1

TABLE 2
NH₄ recovery and nitrification inhibition (second series)

| | | % NH₄ recovery of applied NH₄ | | | | % nitrification inhibition | | | |
|---|---|---|---|---|---|---|---|---|---|
| NI | NI/N (NH₄) | DAT7 | DAT14 | DAT28 | DAT42 | DAT7 | DAT14 | DAT28 | DAT42 |
| — | 0 | 33 | 6 | 0 | 1 | 0 | 0 | 0 | 0 |
| DMPP | 0.8% | 75 | 71 | 64 | 66 | 70 | 76 | 66 | 61 |
| DMPSA | 0.4% | 82 | 73 | 61 | 63 | 76 | 75 | 66 | 56 |

1) NI/N (NH₄): weight ratio of nitrogen inhibitor to nitrogen contributed by ammonium sulfate
2) calculated according to equation 1

The results show that DMPSA provides for longer and stronger inhibition of nitrification in drip irrigation compared to DCD and Nitrapyrin. The results also show that DMPSA is almost twice effective as DMPP and thus only half amount of DMPSA is required to achieve comparable nitrification inhibition.

### EXAMPLE 2

100 g of air dried soil was filled in a 150 mL free draining column made of glass. Soil was moistened with deionized water to 50% of its water holding capacity. Then, the filled column was incubated for 24 h at 20° C. A solution of ammonium sulfate and optionally the nitrogen inhibitor in deionized water was deposited on the soil by means of a pipette to simulate drip irrigation. The amount of ammonium sulfate corresponds to 90 mg of nitrogen (N). The columns were then incubated for 9 days at 20° C. Then, deionized water was dripped to the soil corresponding to a precipitation of about 43 mm. Thereafter, the water was removed from the soil by applying a negative pressure until the moisture in the soil was 50% of its water holding capacity. The removed water (percolate) was collected and analyzed with regard to the total quantity of inorganic nitrogen (NH₄ and NO₃) as described for example 1. Since NH₄ is more strongly bound to the soil compared to NO₃ a lower nitrogen value indicates a better inhibition of nitrification. The results are summarized in table 3:

TABLE 3
Results of the leaching experiment

| AS [mg N] ¹⁾ | NI | NI/N (NH₄) ²⁾ | Total N ³⁾ [mg] |
|---|---|---|---|
| 0 | — | 0 | 0.2 |
| 90 | — | 0 | 9.2 |
| 90 | DMPP | 0.8% | 6.3 |
| 90 | DMPSA | 0.8% | 6.0 |
| 90 | Nitrapyrin | 0.8% | 7.1 |
| 90 | Triazole + 3 MP | 0.8% | 6.6 |

¹⁾ amount of nitrogen initially added as ammonium sulfate
²⁾ NI/N (NH₄): weight ratio of nitrogen inhibitor to nitrogen contributed by ammonium sulfate
³⁾ total quantity of inorganic nitrogen (NH₄ and NO₃)

1. A method of improving the growth and/or the yield of plants grown on agriculturally or horticulturally utilized substrates comprising applying at least one active compound I (nitrification inhibitor) selected from the group consisting of
a) 2-(3,4-dimethyl-1H-pyrazol-1-yl)succinic acid and/or 2-(4,5-dimethyl-1H-pyrazol-1-yl)succinic acid, and/or a derivative thereof, and/or a salt thereof,
on an agriculturally or horticulturally utilized substrate, wherein the at least one active compound I is added to an irrigation system in a water-dissolved form.

2. A method of increasing inhibition of nitrification on agriculturally or horticulturally utilized substrates fertilized with a fertilizer, comprising applying at least one active compound I as defined in claim 1 on an agriculturally or horticulturally utilized substrate, wherein the at least one active compound I is applied by an irrigation system in a water-dissolved form.

3. The method according to claim 1, wherein compound I is selected from the group consisting of compounds I.A, I.B, I.C, I.D and I.E:
I.A: 2-(3,4-dimethyl-1H-pyrazol-1-yl)succinic acid and/or 2-(4,5-dimethyl-1H-pyrazol-1-yl)succinic acid,
I.C: a potassium salt of 2-(3,4-dimethyl-1H-pyrazol-1-yl)succinic acid and/or 2-(4,5-dimethyl-1H-pyrazol-1-yl)succinic acid,
I.D: an ammonium salt of 2-(3,4-dimethyl-1H-pyrazol-1-yl)succinic acid and/or 2-(4,5-dimethyl-1H-pyrazol-1-yl)succinic acid, and
I.E: a sodium salt of 2-(3,4-dimethyl-1H-pyrazol-1-yl)succinic acid and/or 2-(4,5-dimethyl-1H-pyrazol-1-yl)succinic acid.

4. The method according to claim 1, wherein compound I is 2-(3,4-dimethyl-1H-pyrazol-1-yl)succinic acid and/or 2-(4,5-dimethyl-1H-pyrazol-1-yl)succinic acid.

5. The method according to claim 1, wherein compound I is an ammonium salt of 2-(3,4-dimethyl-1H-pyrazol-1-yl)succinic acid and/or 2-(4,5-dimethyl-1H-pyrazol-1-yl)succinic acid.

6. The method according to claim 1, wherein compound I is a potassium salt of 2-(3,4-dimethyl-1H-pyrazol-1-yl)succinic acid and/or 2-(4,5-dimethyl-1H-pyrazol-1-yl)succinic acid.

7. The method according to anyone of the claim 1, wherein additionally a fertilizer (F) is applied on the agriculturally or horticulturally utilized substrate.

8. The method according to claim 1, wherein a mixture comprising the at least one active compound I and a fertilizer (F) is added to the irrigation system.

9. The method according to claim 1, wherein the at least one active compound I is added to the irrigation system and a fertilizer (F) is added to the same irrigation system with a time interval of at least 1 hour.

10. The method according to claim 1, wherein the at least one active compound I is added to the irrigation system and a fertilizer (F) is added to the same irrigation system with a time interval of at least 1 day.

11. The method according to anyone of the claim 1, wherein a fertilizer (F) is applied on the agriculturally or horticulturally utilized substrate without being added to the irrigation system.

12. The method according to anyone of the claim 7, wherein the fertilizer (F) is selected from the group consisting of ammonium nitrate, calcium ammonium nitrate, ammonium sulfate, ammonium sulfate nitrate, calcium nitrate, diammonium phosphate, monoammonium phosphate, ammonium thio sulfate, calcium cyanamide, NP, NK and NPK complex fertilizers, physical mixtures of salts and/or fertilizers each containing N, P and/or K, anhydrous ammonia, urea, urea ammonium nitrate (UAN), urea ammonium sulfate, magnesium salts, calcium salts, sulfur containing compounds, and trace elements selected from the group consisting of manganese (Mn), zinc (Zn), copper (Cu), iron (Fe), boron (B), chlorine (Cl), nickel (Ni), molybdenum (Mo).

13. The method according to anyone of the claim 7, wherein a weight ratio of the active compound I and the fertilizer (F) is from 1:10000 to 1:3.

14. The method according to anyone of the claim 1, wherein no fertilizer (F) is applied on an agriculturally or horticulturally utilized substrate.

15. The method according to anyone of the claim 1, to wherein the active compound I is applied via a drip irrigation system, a trickle irrigation system, a sprinkler irrigation system, a surface irrigation system, a furrow irrigation system, a center pivot irrigation system, an irrigation system based on crop protection sprayers, a vehicle-based irrigation system, and/or a subsurface irrigation system.

16. The method of claim 2, wherein the fertilizer is a nitrogen containing fertilizer.
